(19) United States
(12) Patent Application Publication
(10) Pub. No.: US 2024/0378914 A1
(43) Pub. Date: Nov. 14, 2024

(54) LOGISTICS CONTROL SYSTEM AND METHOD BY USING CAMERA

(71) Applicant: HANWHA VISION CO., LTD., Seongnam-si (KR)

(72) Inventors: Jong Seo LEE, Seongnam-si (KR); Woo Cheol JEONG, Seongnam-si (KR); Joon Tek LEE, Seongnam-si (KR); Woo Won RA, Seongnam-si (KR); Woong JEON, Seongnam-si (KR); KooIl JUNG, Seongnam-si (KR); JeongSeok LEE, Seongnam-si (KR); Jinwook HUH, Seongnam-si (KR); JoongGyun JEONG, Seongnam-si (KR); Jonghyeok LEE, Seongnam-si (KR); Jungmin PARK, Seongnam-si (KR)

(73) Assignee: HANWHA VISION CO., LTD., Seongnam-si (KR)

(21) Appl. No.: 18/778,984

(22) Filed: Jul. 21, 2024

Related U.S. Application Data
(63) Continuation-in-part of application No. 18/124,844, filed on Mar. 22, 2023.

(30) Foreign Application Priority Data
Mar. 22, 2024 (KR) 10-2024-0039580

(51) Int. Cl. G06V 30/224; G06K 19/06; G06Q 10/08

(52) U.S. Cl. CPC G06V 30/2247; G06K 19/06028; G06Q 10/08

(57) ABSTRACT

Provided is a camera included in a logistics control system, the camera including a barcode information obtainer configured to capture an image of a barcode of an article, which is attached to the article, and obtain barcode information of the barcode, an image information obtainer configured as one housing with the barcode information obtainer and configured to obtain image information of the article by capturing an image of the article and be simultaneously triggered by one signal to have a synchronized photographing time point with the barcode information obtainer, and a processor configured to monitor the article based on the barcode information and the image information.

### CROSS-REFERENCE TO THE RELATED APPLICATION

This is a continuation-in-part application of U.S. application Ser. No. 18/124,844 filed on Mar. 22, 2023. In addition, this application claims priority from Korean Patent Application No. 10-2024-0039580, filed on Mar. 22, 2024, in the Korean Intellectual Property Office, the disclosure of which is incorporated herein in its entirety by reference.

### BACKGROUND

### 1. Field

The disclosure relates to a logistics control system and method by using a camera.

### 2. Description of the Related Art

A user may obtain barcode information about an article to check a distribution process of the article in a logistics system. Also, when a problem, such as loss of an article, occurs, the user may check a movement state of an article by directly searching barcode information about the article.

According to the related art, a user has difficulty in directly checking that a problem has occurred in a logistics process by checking barcode information, and has difficulty because of the need to directly search and find whether a problem article exists or find the current location of an article.

According to the related art, in the past, there has been no image-based barcode recognition cameras providing color images, and there is a problem in that image-based barcode readers are unable to distinguish between colors of articles or cargoes because monochrome image sensors are used to improve recognition accuracy.

### SUMMARY

Provided is a logistics control system and method using a camera. However, these problems are illustrative, and the scope of the disclosure is not limited thereto.

Additional aspects will be set forth in part in the description which follows and, in part, will be apparent from the description, or may be learned by practice of the present disclosure.

According to an aspect of the disclosure, a camera included in a logistics control system includes a barcode information obtainer configured to capture an image of a barcode of an article, which is attached to the article, and obtain barcode information of the barcode, an image information obtainer configured as one housing with the barcode information obtainer and configured to obtain image information of the article by capturing an image of the article and be simultaneously triggered by one signal to have a synchronized photographing time point with the barcode information obtainer, and a processor configured to monitor the article based on the barcode information and the image information

The barcode information obtainer and the image information obtainer may capture the article in a common field of view (FOV) area, and the common FOV area may be formed as a common area of a first capturing area captured by the barcode information obtainer and a second capturing area captured by the image information obtainer.

The barcode information module and the image information obtainer may be included in one system-on-chip (SoC) to be simultaneously triggered by one signal to have synchronized photographing time points

The barcode information obtainer may include a liquid lens.

A horizontal or vertical width of the common FOV area may be equal to or greater than a width of a conveyor belt

The barcode information obtainer may include a mono sensor, the image information obtainer may include a color sensor, and the image information obtainer may obtain color information of the article.

The processor may be further configured to generate article status information by inserting the barcode information of the article into a metadata area related to the color information of the article and map the barcode information of the article with the color information of the article based on the article status information.

The processor may be further configured to check a status of the article or a position of the article based on the barcode information of the article and the color information of the article.

The camera may further include a light-emitting diode (LED) arranged on one side of the housing.

Other aspects, features, and advantages other than those described above will become clear from the detailed description, claims, and drawings for carrying out the disclosure below.

### BRIEF DESCRIPTION OF THE DRAWINGS

The above and other aspects, features, and advantages of the present disclosure will be more apparent from the following description taken in conjunction with the accompanying drawings, in which:

FIG. 1 is a diagram for explaining the configuration and operation of a logistics control system;

FIG. 2 is a diagram for describing an example of a conceptual diagram of a logistics control system;

FIG. 3 is a diagram for explaining a logistics control system;

FIG. 4 is a diagram for explaining another logistics control system;

FIG. 5 is a diagram for explaining the configuration of a server included in a logistics control system;

FIG. 6 is a diagram for describing an example of an internal block diagram of a camera;

FIG. 7 is a diagram for describing an example of an internal block diagram of an image-capturing module;

FIG. 8 is a diagram for describing an example of a focus feedback screen of a camera;

FIG. 9 is a diagram for describing an example of a light-emitting diode (LED) setup screen of a camera;

FIG. 10 is a diagram for describing an example of a sensor mode screen of a camera;

FIG. 11 is a diagram for describing an example of a block diagram of an artificial intelligence (AI) device as applied;

FIG. 12 is a diagram for describing an example of an operating method of a barcode reader (BCR) open application;

FIG. 13 is a diagram for describing an example of a BCR platform structure;

FIG. 14 is a flowchart illustrating a logistics control method;

FIG. 15 is a flowchart illustrating an example of a method of performing logistics control;

FIG. 16 is a diagram for describing an example of a common field of view area of a camera;

FIG. 17 is a diagram for describing an example of barcode information of an article;

FIG. 18 is a flowchart illustrating another example of a method of performing logistics control, according to an embodiment;

FIGS. 19 and 20 are diagrams for explaining a logistics control method;

FIG. 21 is a diagram for describing an operation of a server of a logistics control system; and

FIGS. 22 and 23 are diagrams for describing a logistics control method.

### DETAILED DESCRIPTION

Reference will now be made in detail, examples of which are illustrated in the accompanying drawings, wherein like reference numerals refer to like elements throughout. In this regard, the present disclosure may have different forms and should not be construed as being limited to the descriptions set forth herein. Accordingly, the disclosure is merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure will now be described more fully with reference to the accompanying drawings, in which examples of the disclosure are shown. Effects and features of the disclosure, and methods for achieving the effects and features will become clear with reference to the disclosure to be described below in detail together with the drawings. The disclosure may, however, be embodied in many different forms and should not be construed as being limited to the examples set forth herein.

Hereinafter, the disclosure will be described in detail by explaining examples of the disclosure with reference to the attached drawings. Like reference numerals in the drawings denote like elements, and thus their description will be omitted.

In the following disclosure, terms as “first,” “second,” etc., may be used to describe various components, such components must not be limited to the above terms. The above terms are used only to distinguish one component from another. An expression used in the singular encompasses the expression of the plural, unless it has a clearly different meaning in the context. Also, it is to be understood that the terms such as “including,” “having,” and “comprising” are intended to indicate the existence of the features or components disclosed in the specification, and are not intended to preclude the possibility that one or more other features or components may be added.

Sizes of components in the drawings may be exaggerated for convenience of explanation. In other words, since sizes and thicknesses of components in the drawings are arbitrarily illustrated for convenience of explanation, the following disclosure is not limited thereto.

In the following disclosure, it will be understood that when a part, such as a region, a component, a unit, a block, or a module, is referred to as being “on” another part, the part can be directly on the other part or intervening regions, components, units, blocks, or modules may be present thereon. Also, when regions, components, units, blocks, or modules are referred to as being connected to each other, the regions, components, units, blocks, or modules can be directly connected to each other, or the regions, components, units, blocks, or modules can be indirectly connected with other regions, components, units, blocks, or modules therebetween.

Hereinafter, various examples of the disclosure will be described in detail with reference to the accompanying drawings so that those skilled in the art can easily practice the disclosure.

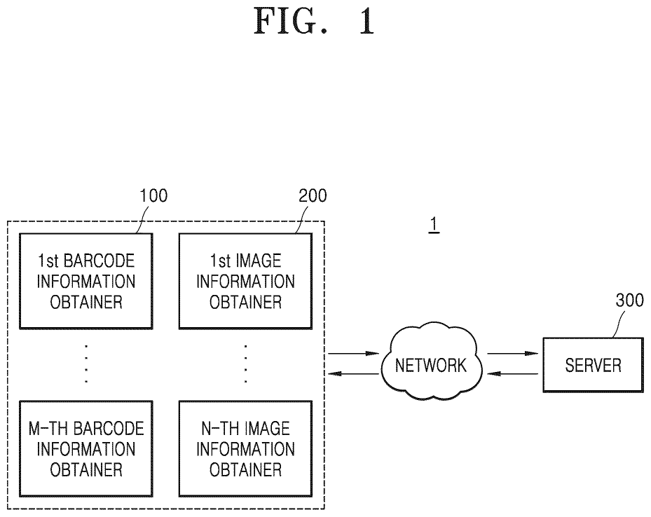

FIG. 1 is a diagram for explaining the configuration and operation of a logistics control system.

Referring to FIG. 1, a logistics control system 1 may include a barcode information obtainer 100, an image information obtainer 200, and a server 300. However, the disclosure is not limited thereto, and the logistics control system 1 may further include other components or some components may be omitted. Some components of the logistics control system 1 may be separated into a plurality of devices, or a plurality of components may be merged into one device.

The barcode information obtainer 100 may be a device provided in the logistics control system 1 to obtain barcode information about an article. For example, a plurality of barcode information obtainers 100 may be provided at drop-off points and loading points in a plurality of terminals of the logistics control system 1. For example, the barcode information obtainer 100 may be installed on each of drop-off and loading conveyors of the logistics control system 1 to obtain barcode information of an article having the barcode information attached to the article.

The image information obtainer 200 may be a device provided in the logistics control system 1 to obtain image information about an article. For example, a plurality of image information obtainers 200 may be provided at the drop-off points and the loading points in the plurality of terminals of the logistics control system 1. For example, the image information obtainer 200 may be installed on each of the drop-off and loading conveyors of the logistics control system 1 to obtain image information about an article.

Also, a photographing time point of the image information obtainer 200 may be synchronized with a photographing time point of the barcode information obtainer 100. For example, a time point when the barcode information obtainer 100 recognizes a barcode of an article may be synchronized with a time point when the image information obtainer 200 captures an image of the same article. For example, at a time point when the barcode information obtainer 100 obtains barcode information about an article, the image information obtainer 200 may obtain image information about the same article at the same time point. Accordingly, the logistics control system 1 according to the disclosure may count articles based on images and barcode information instead of counting articles by using only barcode information.

The server 300 may be a server device that controls the operation of the logistics control system 1. For example, the server 300 may be connected to the barcode information obtainer 100 and the image information obtainer 200 through a network to exchange data with each other. For example, the server 300 may obtain barcode information about an article from the barcode information obtainer 100. Also, the server 300 may obtain image information about an article from the image information obtainer 200. In addition, the server 300 may monitor an article based on the barcode information and the image information about the article.

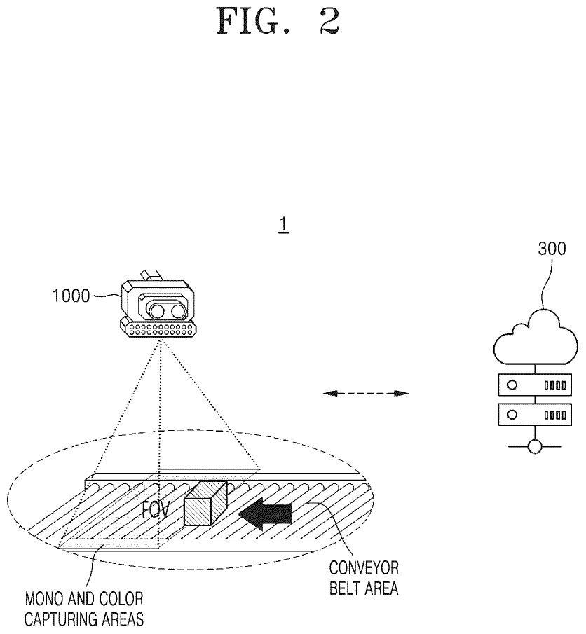

FIG. 2 is a diagram for describing an example of a conceptual diagram of a logistics control system.

The components shown in FIG. 2 are not necessarily required components for implementing a logistics control system (or a logistics monitoring system), so the logistics control system described in the disclosure may include more or fewer components than those listed above.

Referring to FIG. 2, the logistics control system 1 may include a camera 1000 and a server 300.

The logistics control system 1 may capture an image of an article moving through a logistics conveyor belt with the camera 1000, which includes a mono sensor and a color sensor. For example, the logistics control system 1 may obtain barcode information of the article with the mono sensor and obtain color information of the article with the color sensor to analyze the obtained barcode information of the article and the obtained color information of the article to check the status of the article. In addition, the logistics control system 1 may transmit an analysis result to the server 300 to store and manage the analysis result by the server 300 to check whether the article is damaged or stolen, and may obtain metadata about characteristic points such as the size, volume, and pattern of the article.

The camera 1000 and the server 300 may transmit and receive signals or information through a wireless and/or wired network.

The camera 1000 is a device that may implement a method of performing logistics control or logistics monitoring, proposed in the disclosure. The camera may include a barcode reader (BCR) camera, a surveillance camera (or CCTV), an edge device, an artificial intelligence (AI) camera, a network camera, or the like, but a BCR camera is described as an example in the disclosure. However, the disclosure is not limited thereto.

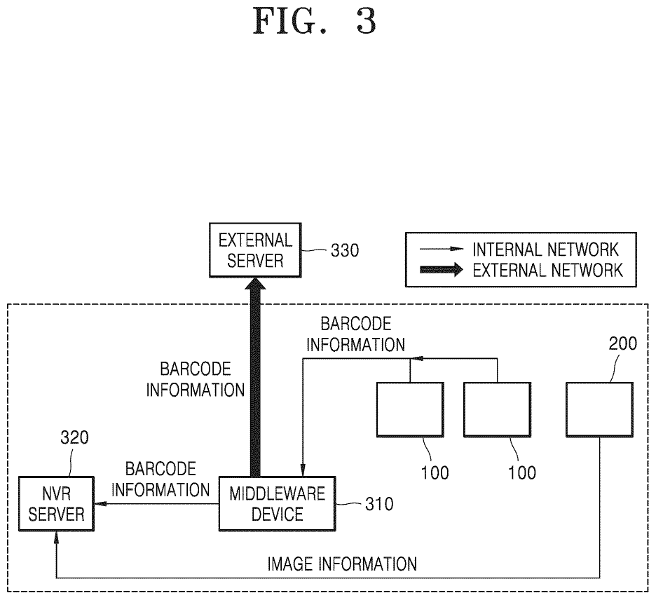

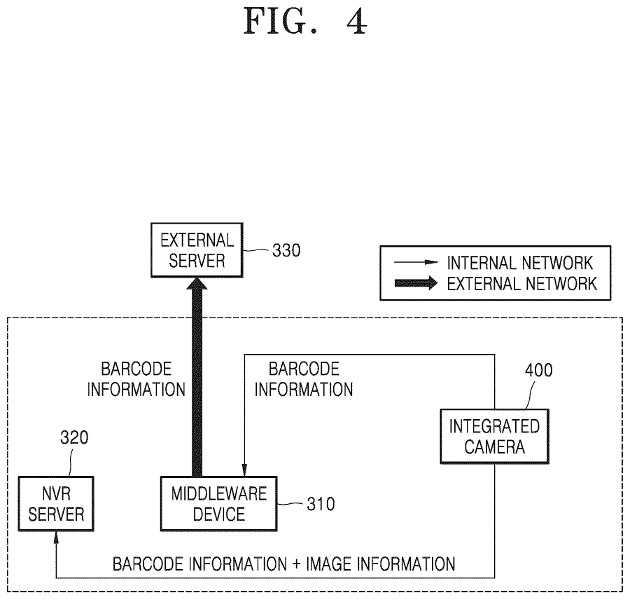

FIG. 3 is a diagram for describing a logistics control system. In addition, FIG. 4 is another diagram for describing a logistics control system.

First, referring to FIG. 3, the logistics control system may include the barcode information obtainer 100, the image information obtainer 200, a middleware device 310, a network video recorder (NVR) server 320, and an external server 330. For example, the barcode information obtainer 100 may include a barcode reader (BCR) camera. Here, the BCR camera may obtain barcode information. For example, the image information obtainer 200 may include a closed-circuit television (CCTV). Here, the CCTV may obtain image information. Also, referring to FIG. 4, the logistics control system may include an integrated camera 400. For example, the integrated camera 400 may be a device configured to perform functions of barcode information obtainer 100 and the image information obtainer 200 in one device. For example, the integrated camera 400 may obtain both barcode information and image information. The NVR server 320 may obtain barcode information and image information by synchronizing the same. For example, the NVR server 320 may store data by tagging based on the time when data is received into the NVR server 320. For example, as shown in FIG. 3, the NVR server 320 may obtain barcode information by tagging time information to the barcode information, based on a time point at which the barcode information is obtained from the middleware device 310. Also, the NVR server 320 may obtain image information by tagging time information to the image information, based on a time point at which the image information is obtained from the CCTV 200. The NVR server 320 may obtain the barcode information and the image information by synchronizing the same, based on the time information tagged to the barcode information and the time information tagged to the image information.

Also, the NVR server 320 may search for an article based on the barcode information. For example, the NVR server 320 may search for image information synchronized with the barcode information, based on the barcode information. In addition, the NVR server 320 may identify an article through the image information synchronized with the barcode information.

The integrated camera 400 may have a first channel for transmitting barcode information and a second channel for transmitting barcode information and image information. For example, as shown in FIG. 4, the integrated camera 400 may transmit barcode information to the middleware device 310 through the first channel, according to a request received from the middleware device 310. Also, the integrated camera 400 may transmit barcode information and image information to the NVR server 320 through the second channel, according to a request received from the NVR server 320.

The logistics control system may include a network consisting of a closed circuit network and an external network. For example, referring to FIGS. 3 and 4, the closed circuit network (e.g., an internal network) may be configured between the BCR camera 100 and the middleware device 310 as well as the NVR server 320 and the CCTV 200. The closed circuit network may also be configured between the middleware device 310, the integrated camera 400, and the NVR server 320. Also, the external network may be configured between the middleware device 310 and the external server 330.

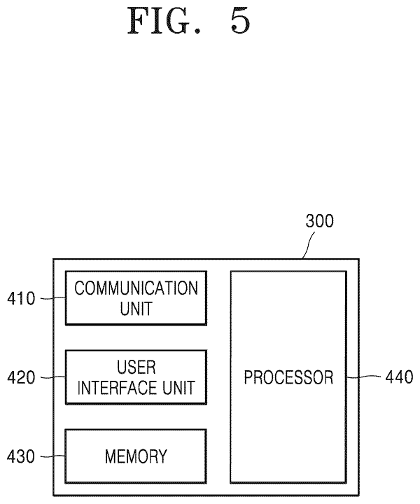

FIG. 5 is a diagram for explaining the configuration of a server included in a logistics control system.

Referring to FIG. 5, the server 300 may include a communication unit 410, a user interface unit 420, a memory 430, and a processor 440.

The communication unit 410 may provide a function for communicating with an external device through a network. For example, a request generated by the processor 440 of the server 300, according to program code stored in a recording device, such as the memory 430, may be transmitted to an external device through a network under the control of the communication unit 410. Conversely, a control signal, command, content, file, or the like provided from the external device may be received by the server 300 through the communication unit 410 via the network. For example, a control signal, command, or the like of the external device received through the communication unit 410 may be transmitted to the processor 440 or the memory 430.

A communication method is not limited, and may include short-distance wireless communication between devices as well as a communication method utilizing a communication network (e.g., a mobile communication network, wired Internet, wireless Internet, broadcasting network) that the network may include. For example, the network may include any one or more of networks, such as personal area network (PAN), local area network (LAN), campus area network (CAN), metropolitan area network (MAN), wide area network (WAN), broadband network (BBN), the Internet, or the like. Also, the network may include any one or more of network topologies including, but not limited to, a bus network, a star network, a ring network, a mesh network, a star-bus network, a tree or hierarchical network, or the like.

In addition, the communication unit 410 may communicate with an external server through a network. A communication method is not limited, but the network may be a short-distance wireless communication network. For example, the network may be Bluetooth, Bluetooth Low Energy (BLE), or a Wi-Fi communication network.

Also, the server 300 may include the user interface unit 420. The user interface unit 420 may interface with an input/output device. For example, the input device may include a device such as a keyboard or mouse, and the output device may include a device such as a display for displaying a communication session of an application. As another example, the user interface unit 420 may also be a unit for interface with a device in which functions for input and output are integrated into one, such as a touch screen. In a more particular example, the processor 440 of the server 300 processes a command of a computer program loaded into the memory 430, such that a service screen or content configured using data provided by an external device may be displayed on the display through the user interface unit 420.

The memory 430 is a computer-readable recording medium and may include random access memory (RAM), read only memory (ROM), and permanent mass storage device such as a disk drive. Also, program code for controlling a logistics control system may be temporarily or permanently stored in the memory 430.

The processor 440 may obtain barcode information from a barcode information obtainer provided in a logistics control system and obtaining barcode information of an article, the barcode information being attached to the article. Also, the processor 440 may obtain image information from an image information obtainer that obtains image information about an article by synchronizing a photographing time point thereof with that of the barcode information obtainer. Also, the processor 440 may monitor an article based on barcode information and image information.

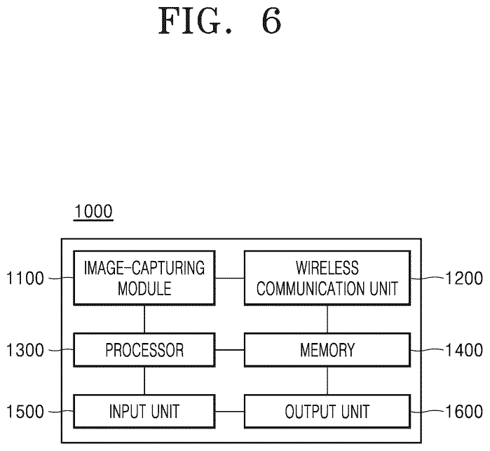

FIG. 6 is a diagram for describing an example of an internal block diagram of a camera.

Referring to FIG. 6, the camera 1000 may include an image-capturing module 1100, a wireless communication unit 1200, a processor 1300, a memory 1400, an input unit 1500, and an output unit 1600.

The image-capturing module 1100 may include the barcode information obtainer 100 and the image information obtainer 200. For example, the barcode information obtainer 100 and the image information obtainer 200 may be expressed as image sensors, and may be configured by including a mono sensor for mono-capturing and a color sensor for color-capturing. The mono sensor may be expressed as the barcode information obtainer 100, and the color sensor may be expressed as the image information obtainer 200.

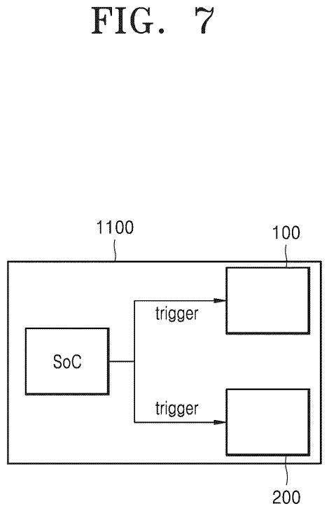

FIG. 7 is a diagram for describing an example of an internal block diagram of an image-capturing module. Referring to FIG. 7, the image-capturing module 1100 may be viewed as including the barcode information obtainer 100 and the image information obtainer 200, which are implemented as a single system-on-chip (SoC).

The barcode information obtainer 100 and the image information obtainer 200 may be simultaneously triggered by one signal in one SoC. For example, the barcode information obtainer 100 and the image information obtainer 200 may be simultaneously triggered by one signal in one SoC, so that the photographing time points of the barcode information obtainer 100 and the image information obtainer 200 may be synchronized.

Here, as shown in the drawing, the barcode information obtainer 100 may be represented by a mono sensor, and the image information obtainer 200 may be represented by a color sensor. For example, the image information obtainer 200 may obtain color information of an article.

A fixed lens or a liquid lens may be applied to the barcode information obtainer 100. In addition, a fixed lens or a liquid lens may also be applied to the image information obtainer 200. In this case, a lens applied to the mono sensor of the barcode information obtainer 100 and a lens applied to the color sensor of the image information obtainer 200 may be the same or different.

For example, a camera that captures images of articles (boxes) moving on a conveyor belt may be fixed and installed above a certain height from the conveyor belt. In this case, because the articles (boxes) moving on the conveyor belt have various sizes, a distance between the articles and the camera changes every time, and thus it is important to achieve quick focus. When a fixed lens is applied to the barcode information obtainer 100, the barcode information obtainer 100 may achieve good focus within a certain range of distances. However, as the distance between the camera and the articles becomes closer than a certain distance, a clear focus can not be achieved. Therefore, a barcode is re-recognized through a ‘barcode recognition algorithm.’

The barcode information obtainer 100 may have a liquid lens. As the speed of a conveyor belt increases, the recognition rate decreases. However, when a liquid lens is applied to the barcode information obtainer 100, a focus may be achieved clearly and quickly to recognize the barcode regardless of the distance between the camera and the articles.

The mono sensor does not include a color filter and absorbs light of all wavelengths, and the color sensor absorbs light of a particular wavelength by including a color filter.

The wireless communication unit 1200 may perform data communication with an external device (a portable device, a server, or the like) through a network. The wireless communication unit 1200 may transmit captured images to an external camera system server or receive control commands from a user.

The wireless communication unit 1200 may include wireless communication modules or the like, such as Bluetooth, Wireless Fidelity (Wi-Fi), near field communication (NFC), wireless broadband internet (Wibro), ultra-wide band communication, Sub-1G, ZigBee, LoRa, or the like.

The processor 1300 generally controls the overall operation of the camera. The processor 1300 may provide or process appropriate information or functions to the user by processing signals, data, information, or the like input or output through the components described above or by driving an application program stored in the memory.

In addition, the processor 1300 may control at least some of the components described with reference to FIG. 6 together to drive the application program stored in the memory. Furthermore, the processor 1300 may operate at least two or more of the components included in the camera in cooperation with each other to drive the application program.

The processor 1300 may monitor the article based on barcode information obtained from the barcode information obtainer 100 and image information obtained from the image information obtainer 200. For example, the barcode information obtainer 100 and the image information obtainer 200 may capture images of articles in a common field of view (FOV) area. Here, the common FOV area may be formed as a common area of a first capturing area captured by the barcode information obtainer 100 and a second capturing area captured by the image information obtainer 200.

The processor 1300 may generate article status information by inserting the barcode information of the article into a metadata area related to the color information of the article and map the barcode information of the article with the color information of the article based on the article status information.

The processor 1300 may check the status or position of the article based on the barcode information of the article and the color information of the article.

The memory 1400 stores data supporting various functions of the camera. The memory 1400 may store a number of application programs or applications being driven by the camera, data for operating the camera, and commands. At least some of these application programs may be downloaded from an external server via wireless communication. An application program may be stored in a memory, installed on the camera, and driven by a processor to perform operations (or functions) of the camera.

The input unit 1500 may include a user input unit (e.g., a touch key, a mechanical key, or the like) for receiving information from the user. The input unit 1500 may further include a camera or image input unit for inputting image signals, a microphone or an audio input unit for inputting audio signals, or the like. Voice data or image data collected from the input unit 1500 may be analyzed and processed as a control command of the user.

The output unit 1600 is configured to generate outputs related to vision, hearing, or tactile senses, and may include a display unit, an audio output unit, or the like.

At least some of the above components may operate in cooperation with each other to implement the operation, control, or a control method of a camera according to various examples to be described below. In addition, the operation, control, or control method of the camera may be implemented on the camera by driving at least one application program stored in the memory.

In addition, the camera 1000 (e.g., a BCR camera) proposed in the disclosure has functions such as focus feedback, light-emitting diode (LED) setup, sensor mode, or the like, and may implement the method proposed in the disclosure through a Wise BCR OpenApp structure.

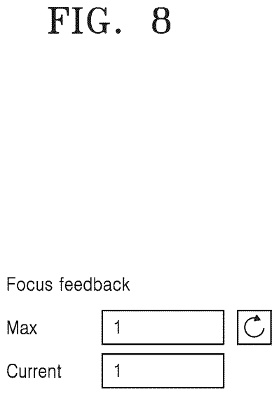

First, the focus feedback function is described. FIG. 8 shows an example of a focus feedback screen of the camera proposed in the disclosure.

The focus feedback function helps the camera find the best focus by showing a current focus peak value through a manual focus.

Referring to FIG. 8, when a focus feedback tab output on the screen of the camera is activated by the user, the focus feedback function is executed, and when a refresh button is input or activated by the user, a MAX value may be initialized.

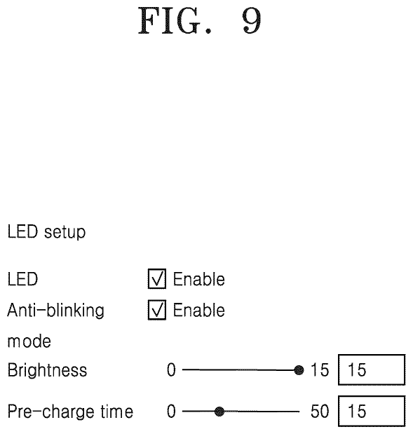

Next, the LED setup function is described. FIG. 9 shows an example of an LED setup screen of the camera proposed in the disclosure.

That is, the camera proposed in the disclosure may further include an LED module, and the LED module may be arranged on one side of a housing that simultaneously includes a barcode information obtainer and an image information obtainer.

The LED setup supports an LED lighting setup of the camera. In particular, the LED setup supports enable, brightness, pre-charge time, and an anti-blinking mode functions.

The enable function sets the turning on/off of the LED, the brightness function sets the current pulse width modulation (PWM) duty of the LED, the pre-charge time function sets the duty of an LED signal to a margin of a few us before/after a shutter cycle.

The anti-blinking mode function activates high-frequency lighting to prevent lighting from blinking when being enabled or activated.

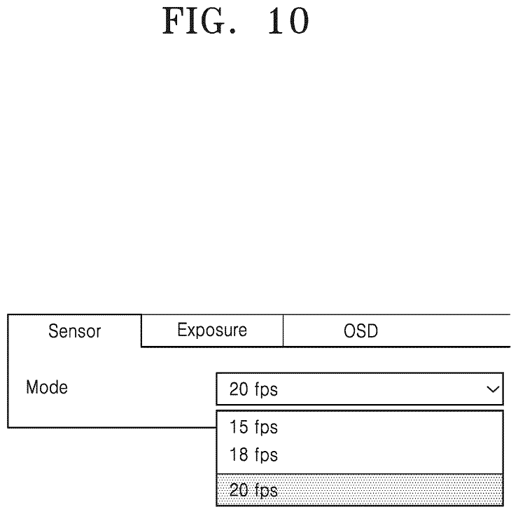

Next, the sensor mode is described. FIG. 10 shows an example of a sensor mode screen of the camera proposed in the disclosure.

The sensor mode is a mode for securing AI performance, which supports 15, 18, and 20 fps, reboots the camera when the sensor mode is changed, resets an input pipeline, and re-execute the WiseBCR App.

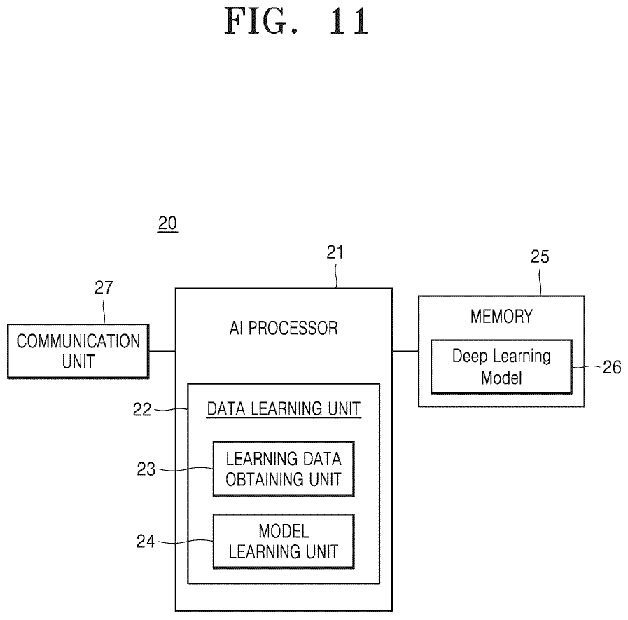

FIG. 11 is a diagram for describing an example of a block diagram of an AI device as applied.

An AI device 20 may be included as at least a portion of the camera 1000 or the server 300 shown in FIG. 2 and may be equipped to perform at least part of AI processing together.

The AI device 20 may include an AI processor 21, a memory 25, and/or a communication unit 27. When the AI device 20 is included in the camera 1000, the communication unit 27 may be omitted.

The AI device 20 is a computing device capable of learning neural networks, and may be implemented with various electronic devices such as cameras, servers, desktop personal computers (PC), laptop PCs, tablet PCs, or the like.

The AI processor 21 may learn a neural network by using a program stored in the memory 25. In particular, the AI processor 21 may learn a neural network for recognizing image-related data. Here, the neural network for recognizing image-related data may be designed to simulate the structure of human brain on a computer, and may include a plurality of network nodes with weights, which simulates neurons of a human neural network. A plurality of network nodes may exchange data according to each connection relationship to simulate the synaptic activity of neurons sending and receiving signals through synapses. Here, the neural network may include a deep learning model developed from a neural network model. In the deep learning model, the plurality of network nodes are located in different layers and may exchange data according to convolutional connection relationships.

For example, examples of the neural network model may include various deep learning techniques such as deep neural networks (DNN), convolutional deep neural networks (CNN), recurrent Boltzmann machine (RNN), restricted Boltzmann machine (RBM), deep belief networks (DBN), and deep Q-Network, and may be applied to fields such as computer vision, speech recognition, natural language processing, and voice/signal processing.

A processor performing the above functions may be a general-purpose processor (e.g., a central processing unit (CPU), or may be an AI-specific processor (e.g., a graphics processing unit (GPU) for AI learning.

The memory 25 may store various types of programs and data necessary for the operation of the AI device 20. The memory 25 may be implemented with non-volatile memory, volatile memory, flash-memory, a hard disk drive (HDD), or a solid state drive (SDD). The memory 25 may be accessed by the AI processor 21, and reading/writing/modifying/deleting/updating data by the AI processor 21 may be performed. In addition, the memory 25 may store a neural network model (e.g., a deep learning model 26 and a Re-ID model 28) generated through a learning algorithm for image analysis.

The AI processor 21 may include a data learning unit 22 that learns a neural network for image analysis. The data learning unit 22 may learn standards regarding what learning data to use to determine image analysis and how to classify and recognize data by using the learning data. The data learning unit 22 may lean a deep learning model by obtain learning data to be used for learning and applying the obtained learning data to a deep learning model.

The data learning unit 22 may be manufactured in the form of at least one hardware chip and mounted on the AI device 20. For example, the data learning unit 22 may also be manufactured in the form of a dedicated hardware chip for AI, or may be manufactured as a part of a CPU or GPU and mounted on the AI device 20. In addition, the data learning unit 22 may be implemented as a software module. When the data learning unit 22 is implemented as a software module (or a program module including instructions), the software module may be stored in non-transitory computer readable media that may be read by a computer. In this case, at least one software module may be provided by an operating system (OS) or an application.

The data learning unit 22 may include a learning data obtaining unit 23 and a model learning unit 24.

The learning data obtaining unit 23 may obtain learning data necessary for a neural network model for image analysis. For example, the learning data obtaining unit 23 may obtain image data and/or sample data to be input to a neural network model as learning data.

The model learning unit 24 may use the obtained learning data so that the neural network model learns to have a determination standard on how to classify certain data. At this time, the model learning unit 24 may train a neural network model through supervised learning that uses at least some of the pieces of learning data as a determination standard. Alternatively, the model learning unit 24 may train a neural network model, through unsupervised learning, which discovers a determination standard, by learning on its own by using the learning data without guidance. In addition, the model learning unit 24 may train a neural network model through reinforcement learning by using a feedback on whether a result of situation determination according to learning is correct. In addition, the model learning unit 24 may train a neural network model by using a learning algorithm including error back-propagation or gradient descent.

When a neural network model is trained, the model learning unit 24 may store the trained neural network model in a memory. The model learning unit 24 may also store the trained neural network model in a memory of a server connected to the AI device 20 through a wired or wireless network.

The data learning unit 22 may also further include a learning data pre-processing unit (not shown) or a learning data selection unit (not shown) to improve analysis results of a recognition model or to save resources or time required for generating a recognition model.

The learning data pre-processing unit may pre-process the obtained data so that the obtained data may be used in learning for situation determination. For example, the learning data pre-processing unit may process the obtained data into a preset format so that the model learning unit 24 may use the obtained learning data for learning image recognition.

In addition, the learning data selection unit may select data required for learning among the learning data obtained from the learning data obtaining unit or the learning data pre-processed in the pre-processing unit. The selected learning data may be provided to the model learning unit 24. For example, the learning data selection unit may detect a particular area among the image obtained through the camera to select only data for an object included in the particular area as learning data.

In addition, the data learning unit 22 may also further include a model evaluation unit (not shown) to improve the analysis results of the neural network model.

The model evaluation unit may input evaluation data into a neural network mode; and when the analysis result output from the evaluation data does not meet a certain standard, the model evaluation unit may allow the model learning unit 22 to learn again. In this case, the evaluation data may be predefined data for evaluating a recognition model. For example, the model evaluation unit may evaluate the analysis result as not meeting a certain standard when the number or ratio of inaccurate evaluation data among analysis results of the learned recognition model for the evaluation data exceeds a preset threshold.

The communication unit 27 may transmit the results of AI processing by the AI processor 21 to an external device.

The AI device 20 shown in FIG. 11 has been described as functionally divided into the AI processor 21, the memory 25, the communication unit 27, or the like, but the above mentioned components are integrated into one module and are referred to as an AI module.

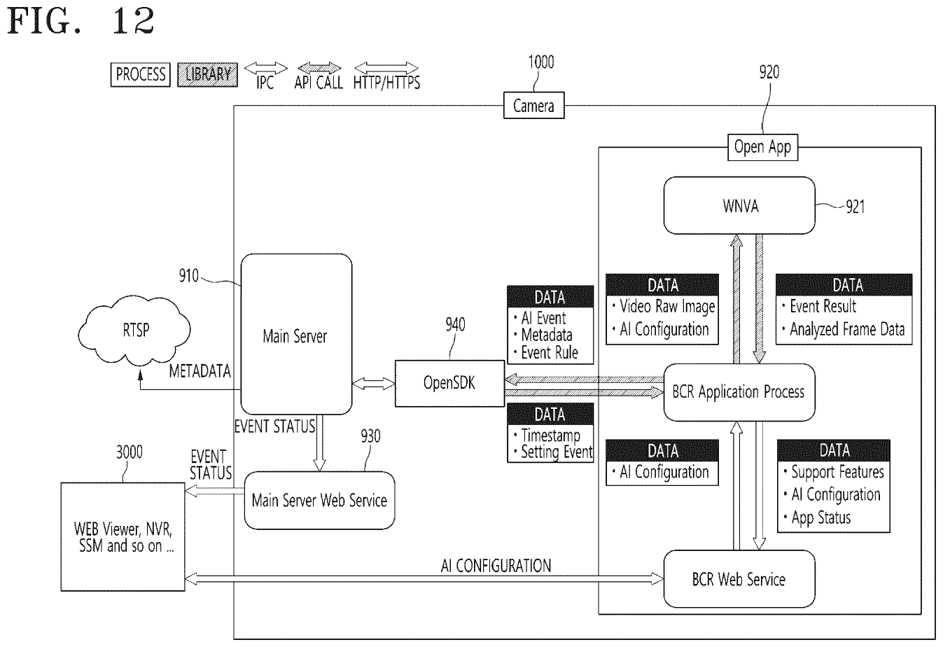

FIG. 12 is a diagram for describing an example of an operating method of a BCR open application.

Referring to FIG. 12, a BCR open application that performs the method of checking the logistics control or article status proposed in the disclosure may communicate with a processor (or a main server) of the camera.

The operating method of the BCR open application is described in more detail.

The main server of the camera 1000 may mean a processor of the camera, and the main server communicates with an open application 920 stored in a memory through an OpenSDK 940.

Also, a wise net video analytics (WNVA) library 921 of the open application may be a core library for video (or image) analysis.

That is, the WNVA analyzes raw video frames and transmits an analysis result about whether an event has occurred and about an object (or object) to the outside.

That is, the WNVA may confirm and analyze whether barcode information of an article and color information of an article has been obtained from the captured images through a barcode information obtainer and an image information obtainer, and may transmit an analysis result to an external device.

The open application transmits settings and video raw frames to the WNVA.

There are two types of metadata related to open application operations, which are frame metadata and event metadata in an XML format.

The frame metadata and event metadata are generated based on analysis results of each video raw frame from the WNVA.

The metadata is transmitted to the main server through the open SDK, and the main server transmits the metadata to an external device through a real time streaming protocol (RTSP).

A web viewer uses frame metadata to overlay objects in a video (or image) and display edges of the video by using the event metadata when an object is detected.

In addition, an event status refers to information delivered from the WNVA when an object set by each AI function is detected.

The open application configures events received by the WNVA into event metadata and transmits the event metadata to the main server of the camera by using an open SDK application programming interface (API).

A web service 930 serves to transmit and receive information between the open application and an external device (backend product) 3000 such as a web viewer, a network video recorder (NVR), a smart security manager (SSM), and the main process processes GET/SET settings requested by the backend product.

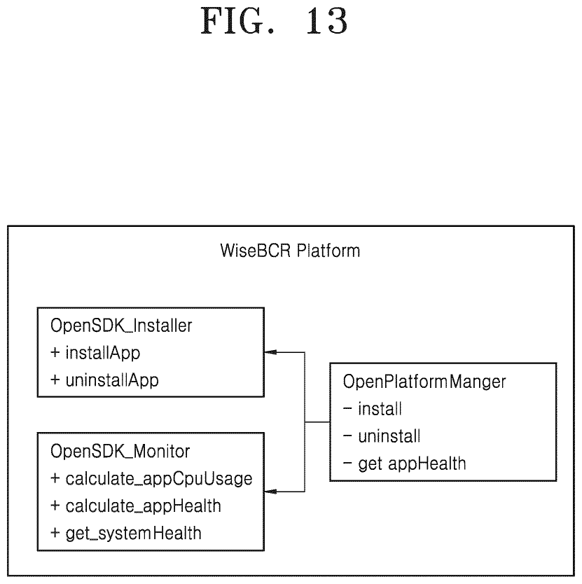

Next, the operation of an OpenPlatform Manager is described. FIG. 13 shows an example of a BCR platform structure proposed in the disclosure.

Referring to FIG. 13, a WiseBCR platform may operate install/uninstall, run, resource control, or the like.

First, install/uninstall means installing an application from a permitted area. Run is executing an application. And, resource control is checking the use of memory and checking whether a resource limit has been exceeded.

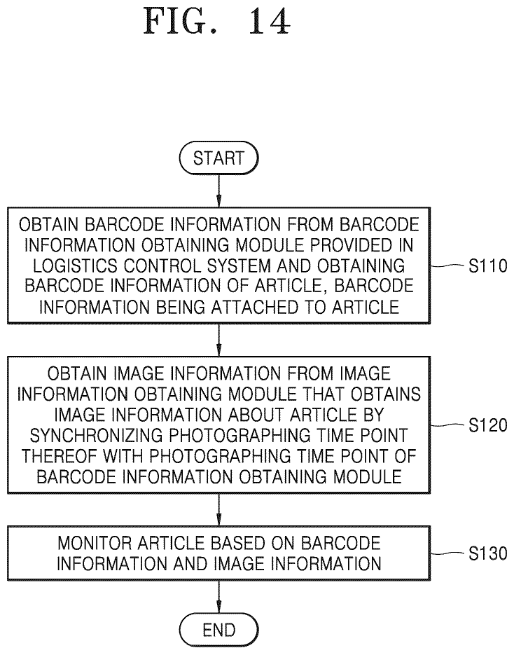

FIG. 14 is a flowchart showing a logistics control method.

Referring to FIG. 14, in operation S110, the processor 340 may obtain barcode information from a barcode information obtainer provided in a logistics control system and obtaining barcode information of an article, wherein the barcode information is attached to the article. For example, the barcode information obtainer may obtain barcode information of an article moving on a conveyor and transmit the obtained barcode information to the processor 340. For example, barcode information of an article may include information such as an invoice number, a barcode number, and a barcode included in an invoice attached to the article.

The barcode information obtainer 100 may obtain barcode information for each of a plurality of articles moving on a conveyor of the logistics control system. For example, the barcode information obtainer 100 may obtain barcode information of an article that passes a predetermined zone on a conveyor at a time point when the article passes the predetermined zone on the conveyor.

The processor 340 may obtain barcode information of articles respectively from a first barcode information obtainer provided at a first location and a second barcode information obtainer provided at a second location. For example, the processor 340 may obtain barcode information from the first barcode information obtainer provided at the first location, which is a drop-off point in a terminal. Also, the processor 340 may obtain barcode information from the second barcode information obtainer provided at the second location, which is a loading point in the terminal.

In operation S120, the processor 340 may obtain image information from an image information obtainer that obtains image information about an article by synchronizing a photographing time point thereof with that of the barcode information obtainer. For example, the image information obtainer may obtain image information of an article moving on a conveyor and transmit the obtained image information to the processor 340. For example, image information of an article may include information such as a video or image of the article moving on the conveyor.

The image information obtainer 200 may obtain image information of each of a plurality of articles moving on a conveyor of the logistics control system. For example, the image information obtainer 200 may obtain image information of an article that passes a predetermined zone on a conveyor at a time point when the article passes the predetermined zone on the conveyor.

In addition, the image information obtainer 200 may obtain image information about an article at the same time point as a time point when the barcode information obtainer 100 obtains barcode information of an article, wherein the article of which the image information is obtained by the image information obtainer 200 is same as the article of which the barcode information is obtained by the barcode information obtainer 100. That is, the photographing time point of the barcode information obtainer 100 may be synchronized with the photographing time point of the image information obtainer 200, so that the barcode information obtainer 100 and the image information obtainer 200 may match and obtain barcode information and image information of each of a plurality of articles moving on a conveyor.

The processor 340 may obtain image information of articles respectively from a first image information obtainer and a second image information obtainer, wherein the first image information obtainer is provided at the first location and having a photographing time point synchronized with that of the first barcode information obtainer, and the second image information obtainer is provided at the second location and having a photographing time point synchronized with that of the second barcode information obtainer.

In addition, the processor 340 may calculate the number of articles by recognizing articles, based on image information obtained from the first image information obtainer and the second image information obtainer. For example, the processor 340 may calculate the number of articles passing through the first location, based on the image information obtained by the first image information obtainer provided at the first location. Also, the processor 340 may calculate the number of articles passing through the second location, based on the image information obtained by the second image information obtainer provided at the second location.

In operation S130, the processor 340 may monitor an article based on the barcode information and the image information. For example, the processor 340 may monitor a moving state of an article in the logistics control system based on the barcode information and the image information of the article.

The processor 340 may monitor moving states of articles in the logistics control system, based on first barcode information and first image information of an article at the first location, and second barcode information and second image information of an article at the second location. For example, the processor 340 may monitor moving states of a plurality of articles, based on barcode information and image information of each of the plurality of articles at the first location, which is a drop-off point in a terminal, and barcode information and image information of each of the plurality of articles at the second location, which is loading point in the terminal.

Also, the processor 340 may find out an article with an unrecognized barcode by comparing article information in the first barcode information with article information in the first image information. In addition, the processor 340 may recognize barcode information of an unrecognized article by mapping the first barcode information and the first image information. For example, the processor 340 may find out an article with an unrecognized barcode by comparing a list of articles passing through the first location, which is identified based on the barcode information, with a list of articles passing through the first location, which is identified based on the image information.

Also, the processor 340 may determine whether an article is lost between the first location and the second location, based on the first barcode information and the first image information, and the second barcode information and the second image information. For example, the processor 340 may determine whether an article is lost between the first location and the second location, based on a list of articles at the first location, which is identified through the first barcode information and the first image information, and a list of articles at the second location, which is identified through the second barcode information and the second image information.

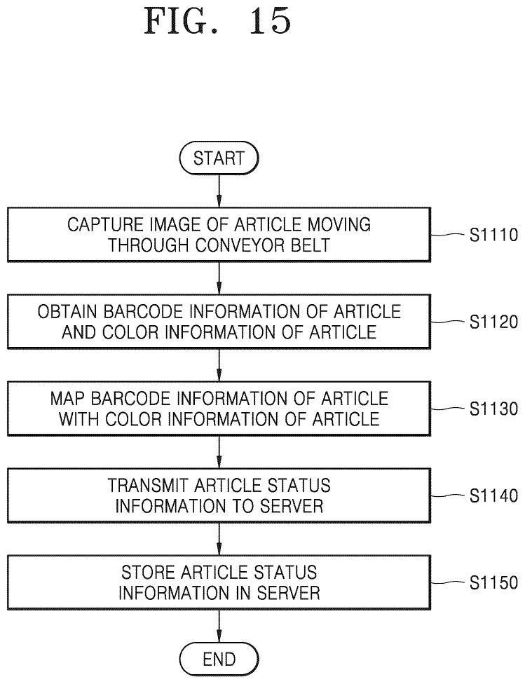

FIG. 15 is a flowchart illustrating an example of a method of performing logistics control.

First, a camera captures one or more objects moving through a conveyor belt in operation S1110.

Also, the camera obtains barcode information of an article through a barcode information obtainer in a common FOV area of the barcode information obtainer and an image information obtainer, which are included in a camera module of the camera, and obtains color information through the image information obtainer in operation S1120.

The common FOV area may be set differently depending on the arrangement of the barcode information obtainer and the image information obtainer, which are implemented in the camera module.

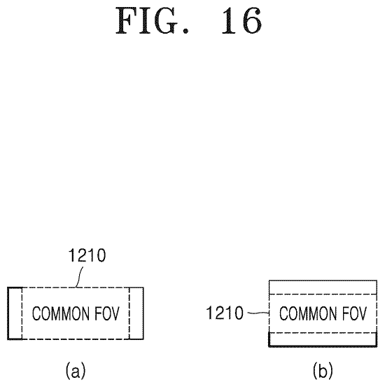

FIG. 16 is a diagram showing an example of a common FOV area of the camera proposed in the disclosure.

FIG. 16A shows a common FOV area 1210 when the barcode information obtainer 100 and the image information obtainer 200 are arranged horizontally on the conveyor belt. FIG. 16B shows the common FOV area 1210 when the barcode information obtainer and the image information obtainer are arranged vertically on the conveyor belt. For example, the width (either horizontal or vertical) of the common FOV area may be equal to or greater than the width of the conveyor belt. For example, the horizontal or vertical width of the common FOV area may be equal to or greater than the width of the conveyor belt.

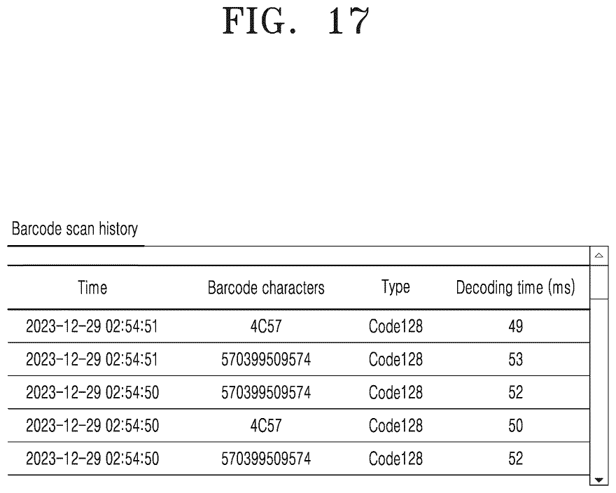

FIG. 17 is a diagram for describing an example of barcode information of an object.

Referring to FIG. 17, it may be seen that barcode information is recorded for each barcode.

The barcode information obtainer may be a mono sensor that performs mono capturing, and the image information obtainer may be a color sensor that performs color capturing, and the camera may be a BCR camera.

The barcode information obtainer and the image information obtainer are simultaneously triggered by one signal, so that the photographing time points thereof are synchronized.

Here, the reason why the color information of the article must be obtained through the image information obtainer is because the condition of the product, such as damage to the product, may not be properly determined only with the barcode information obtained through the barcode information obtainer.

That is, when the color of the article appears blurred in the color information of the article, it may be assumed that the article is damaged.

In addition, the logistics control system proposed in the disclosure adds barcode information of the article, color information of the article, and a stereo camera function, so that information about the scale of the article (or cargo), such as size and volume, may also be checked.

In addition, the logistics control system proposed in the disclosure may additionally obtain color information of an article, thereby enabling tracking for the position of the article for which the barcode information of the article is not recognized.

Also, the camera proposed in the disclosure may reduce the unmatching FOV capture by each sensor by configuring the barcode information obtainer and the image obtainer in one housing and in one SoC in the camera.

That is, in a related art, as an image of an object is captured by using two cameras including one sensor in each camera, there is a gap in a frame of an image captured by each camera due to the difference in speed of a conveyor belt transporting the articles, making it difficult for the barcode of the article to be properly recognized.

However, the logistics control system proposed in the disclosure solves the problem of frame gaps occurring due to the speed of the conveyor belt by horizontally or vertically arranging two image sensors implemented with one SoC in one camera.

In addition, when an image of an object is captured by using two cameras in the related art, even when each camera is set to the same fps, and the power of each camera is turned on at the same time, there is a difference in the initial start time of fps depending on the specification (performance) of each camera, resulting in a gap between the fps of the two cameras. As a result, problems arose where a barcode image and a color image did not match properly. (For example, in the barcode image, an object is positioned in the center of the FOV, but in the color image matched with the barcode image, the article has already passed, so only a portion of the article is visible in the FOV.)

However, a one-body camera, proposed in the disclosure, in which the barcode information obtainer and the image information obtainer are included in one housing and one SoC within the camera is simultaneously triggered with one signal in one Soc, and thus image mismatch was solved.

Here, the camera may analyze the obtained barcode information of the article and the obtained color information of the article by utilizine the AI device (or AI module) shown in FIG. 11 and the BCR open application operation procedure shown in FIG. 12, and may provide an analysis result to an external device.

Also, the camera maps the obtained barcode information of the article with the obtained color information of the article in operation S1130.

The camera generates article status information by inserting the barcode information of the article obtained by the barcode information obtainer into a metadata area related to the color information of the article obtained by the image information obtainer.

Accordingly, the logistics control system may track the color image of the article with a timeline for each barcode information (or barcode data) of the article.

Also, the camera transmits the generated article status information to a server connected to the camera through a network in operation S1140.

The server stores and manages the received article status information in a database in operation S1150.

That is, the camera or the server may check the status of the article or track the position of the article based on the obtained barcode information of the article and the obtained color information of the article.

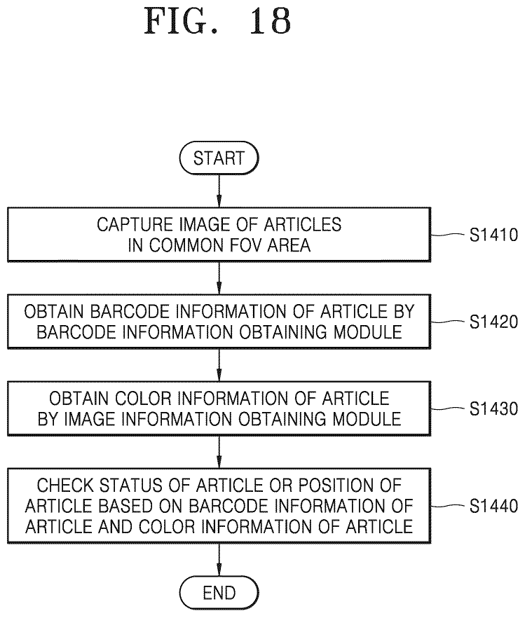

FIG. 18 is a flowchart illustrating another example of a method of performing logistics control.

First, a camera captures an image of one or more articles moving through a conveyor belt in a common FOV area formed by a barcode information obtainer and an image information obtaining mode, which are simultaneously triggered by one signal and the photographing time points thereof are synchronized, in operation S1410.

Also, the camera obtains barcode information of the article from the captured image by the barcode information obtainer in operation S1420.

Also, the camera obtains color information of the article from the captured image by the image information obtainer in operation S1430.

Here, it is preferable that operations S1420 and S1430 are simultaneously performed, and each operation is described separately for convenience of understanding and explanation.

Also, the camera checks the status of the article or the position of the article based on the obtained barcode information of the article and the obtained color information of the article in operation S1440.

Additionally, the camera may map the obtained barcode information of the article with the obtained color information of the article.

More particularly, the camera may map the barcode information of the article with the color information of the article by inserting the barcode information of the article into a metadata area included in the color information of the article to generate article status information.

Also, the camera may transmit the generated article status information to a server.

In addition, the camera may check whether a first capturing area captured by the barcode information obtainer matches a second capturing area captured by the image information obtainer, and when the first capturing area and the second capturing area do not match, the camera may synchronize the triggering time points of the barcode information obtainer and the image information obtainer.

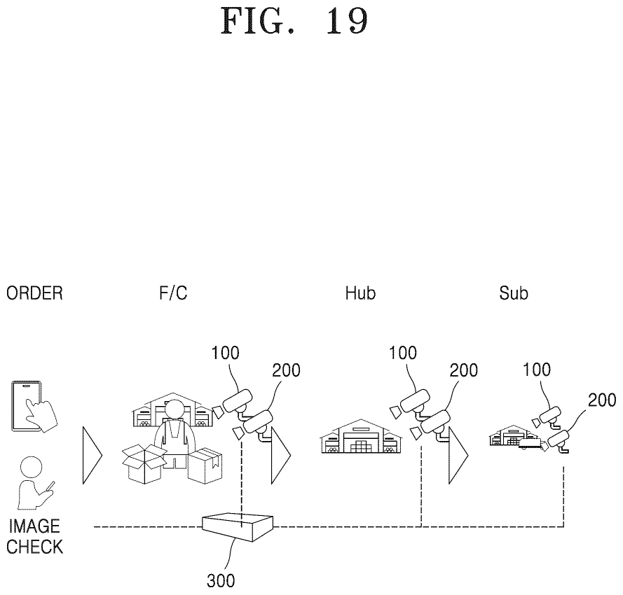

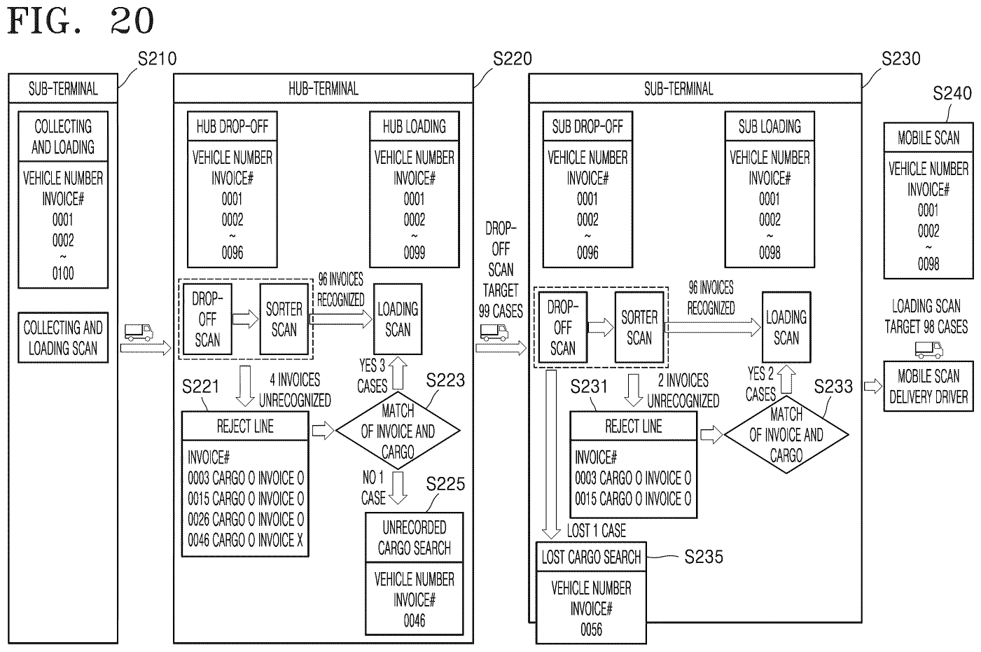

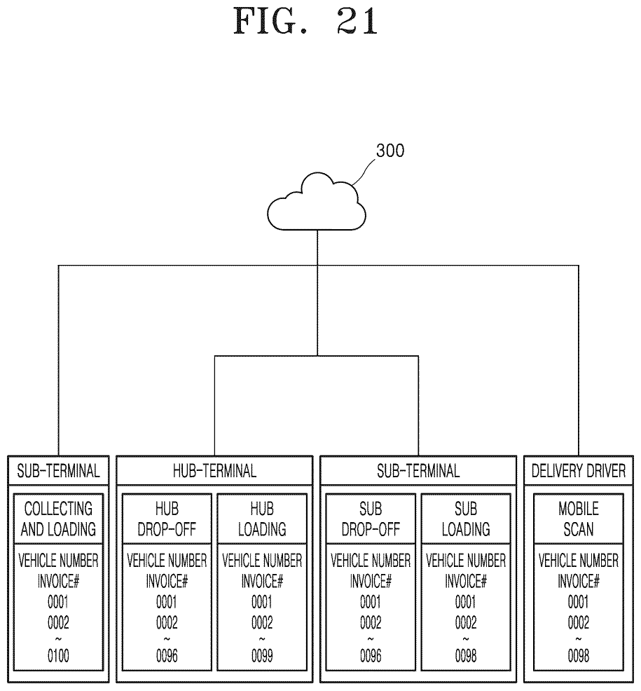

FIGS. 19 and 20 are diagrams for explaining operations of a logistics control system. Also, FIG. 21 is a diagram for explaining an operation of a server of a logistics control system.

Referring to FIG. 19, a logistics control system in which the barcode information obtainer 100 and the image information obtainer 200 are provided in each logistics terminal is shown. Here, the barcode information obtainer 100 and the image information obtainer 200, which are provided in each logistics terminal, may each be connected to the server 300 through a network.

Based on synchronized barcode information and image information, an integrated solution for picking and packing processes may be provided, and end-to-end images may be provided. Accordingly, evidence data for picking errors and packing errors may be provided, and articles in a logistics system may be tracked.

FIG. 20 shows an operation of a logistics control system according to a logistics flow.

In accordance with the need for tracking and managing a troubled cargo (unrecorded/lost/stolen) when it occurs in a logistics process, the logistics control system may check lost/stolen/deviation/unrecorded cases early enough through searching for remaining articles in individual terminals of Hub and Sub. Also, the logistics control system may search for remaining articles between centers by grouping hub-terminals, sub-terminals, and delivery drivers based on cloud linkage. In addition, the logistics control system may detect the possibility of the occurrence of conflict for each process at an early stage through an image-based article counting solution.

Also, Unrecorded cargo invoice tracking and matching solutions may be provided to prevent an accident in which delivery cannot proceed when an invoice is missing. For example, in the tracking of unrecorded cargo invoices, an original invoice may be matched with an unrecorded cargo by checking the original invoice of an article based on images by tracking a delivery history through before/after cargo invoice images.

For example, as shown in FIG. 20, in operation S210, in a sub-terminal, one hundred invoice numbers and one hundred images with respect to one hundred articles may respectively be obtained through a barcode information obtainer and an image information obtainer. For example, the one hundred images may represent one hundred image frames at the same time points as one hundred times of barcode obtaining time points of which the barcode information obtainer obtains barcode information for one image captured by the image information obtainer.

For example, referring to FIG. 21 together, information on vehicle numbers, invoice numbers 1 to 100, and images 1 to 100 at collecting and loading points in a sub-terminal may be stored in the server 300. For example, the server 300 may be a cloud server.

In operation S220, at a hub drop-off point in a hub-terminal, ninety six invoice numbers and one hundred images with respect to one hundred articles may be respectively obtained through the barcode information obtainer and the image information obtainer. Also, at a hub loading point, ninety nine invoice numbers and ninety nine images with respect to ninety nine articles may respectively obtained through the barcode information obtainer and the image information obtainer.

For example, referring to FIG. 21 together, information on vehicle numbers, invoice numbers, and images at hub drop-off and hub loading points of the hub-terminal may be stored in the server 300. For example, the server 300 may be a cloud server.

In operation S221, at the hub drop-off point of the hub-terminal, an article with an unrecognized invoice may be found out based on barcode information and image information respectively obtained through the barcode information obtainer and the image information obtainer. For example, as shown in FIG. 20, articles with invoice numbers 3, 15, 26, and 46 are cargoes for which the number of articles is counted in obtained image information but are cargoes for which barcode information has not been identified within obtained barcode information. Here, articles with invoice numbers 3, 15, and 26 are cargoes with invoices attached thereto, but the barcodes thereof are not recognized. The article with invoice number 46 is a cargo without an invoice attached thereto. In this case, the article with invoice number 46 may have been dropped out in a logistics process. For example, an invoice may include barcode information.

In operation S223, an invoice and an article may be matched for an unrecognized article based on the barcode information and the image information respectively obtained through the barcode information obtainer and the image information obtainer. For example, as shown in FIG. 20, articles and invoices may be matched for the articles with invoice numbers 3, 15, and 26, based on barcode information and image information, which have synchronized photographing time points with respect to the articles with invoice numbers 3, 15, and 26.

In operation S225, an original invoice and an article may be matched with respect to an article of which the invoice is missing, based on the barcode information and the image information respectively obtained through the barcode information obtainer and the image information obtainer. For example, as shown in FIG. 20, an original invoice may be matched with the article with invoice number 46, based on original invoice information and image information obtained in the sub-terminal in operation S210 and image information obtained in the hub-terminal in operation S220 with respect to the article with invoice number 46, from which the invoice is missing.

In operation S230, at a sub drop-off point of the sub-terminal, ninety six invoice numbers and ninety eight images with respect to ninety nine articles may be respectively obtained through the barcode information obtainer and the image information obtainer. Also, at a sub loading point, 98 invoice numbers and ninety eight images with respect to ninety eight articles may respectively obtained through the barcode information obtainer and the image information obtainer.

For example, referring to FIG. 21 together, information on vehicle numbers, invoice numbers, and images at the sub drop-off and sub loading points of the sub-terminal may be stored in the server 300. For example, the server 300 may be a cloud server.

In operation S231, at the sub drop-off point of the sub-terminal, an article with an unrecognized invoice may be found out based on barcode information and image information respectively obtained through the barcode information obtainer and the image information obtainer. For example, as shown in FIG. 20, articles with invoice numbers 3 and 15 are cargoes for which the number of articles is counted in obtained image information but are cargoes for which barcode information has not been identified within obtained barcode information. Here, the articles with invoice numbers 3 and 15 are cargoes having invoices attached thereto but whose barcodes are not recognized. For example, an invoice may include barcode information.

In operation S233, an invoice and an article may be matched for an unrecognized article based on the barcode information and the image information respectively obtained through the barcode information obtainer and the image information obtainer. For example, as shown in FIG. 20, articles and invoices may be matched for the articles with invoice numbers 3 and 15, based on barcode information and image information, which have synchronized photographing time points with respect to the articles with invoice numbers 3 and 15.

In operation S235, lost articles may be searched for based on a plurality pieces of barcode information and image information obtained through a plurality of barcode information obtainers and image information obtainers. For example, as shown in FIG. 20, an article with invoice number 56 may be searched for based on the barcode information and the image information obtained at the hub loading point of the hub-terminal in operation S220 and the barcode information and the image information obtained at the sub drop-off point of the sub-terminal in operation S230.

In operation S240, at a delivery driver loading point, 98 invoice numbers and 98 images for 98 articles may be respectively obtained through the barcode information obtainer and the image information obtainer. For example, referring to FIG. 21, information on vehicle numbers, invoice numbers 1 to 98, and images 1 to 98 at the delivery driver loading point may be stored in the server 300.

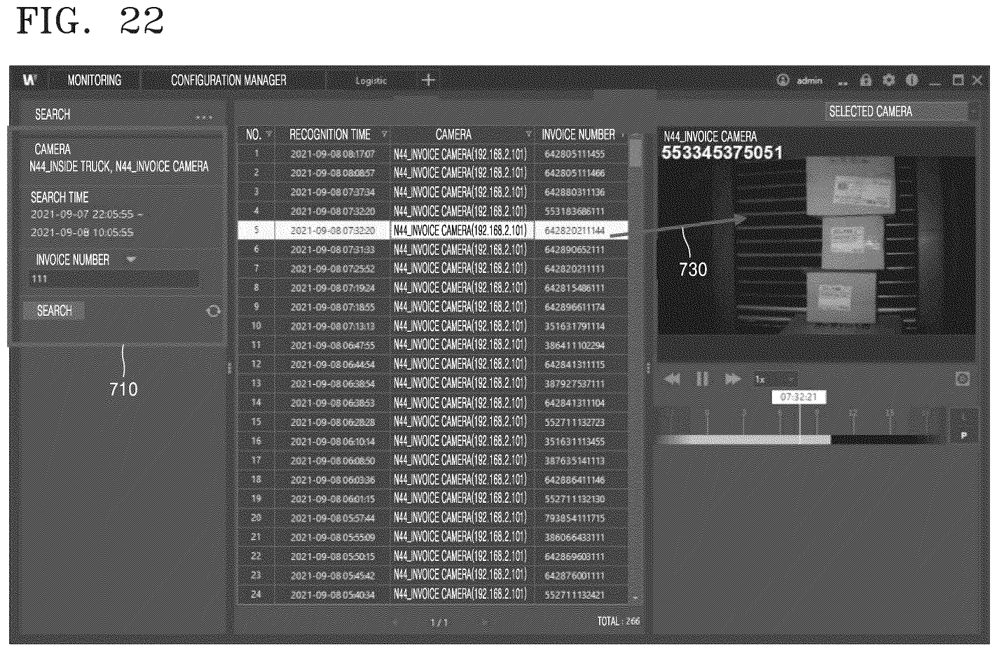

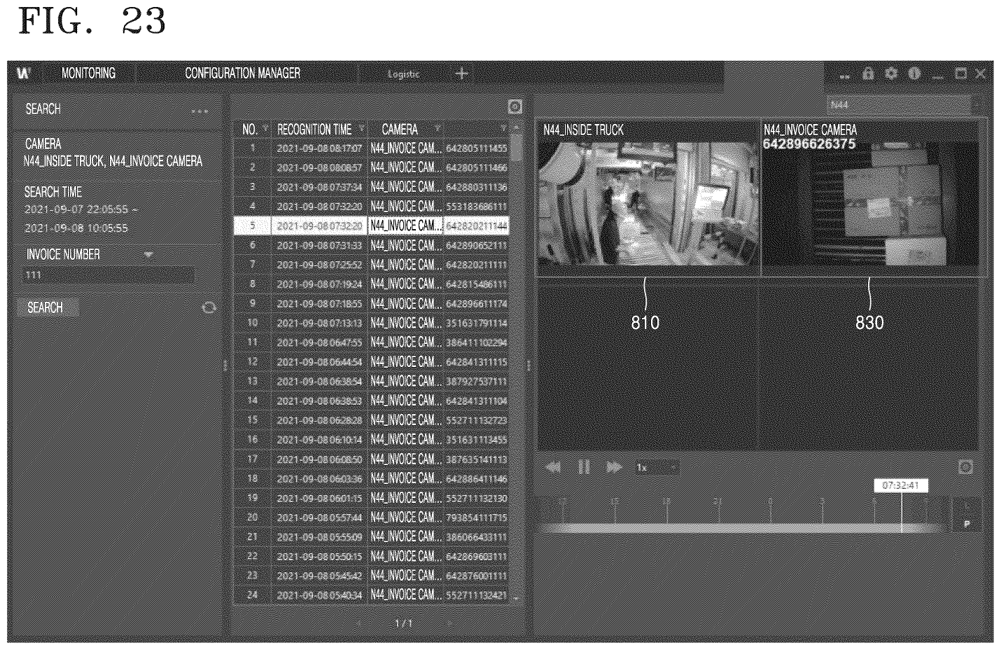

FIGS. 22 and 23 are diagrams for explaining a logistics control method.

Referring to FIGS. 22 and 23, a user interface screen capable of checking barcode information and image information respectively obtained through a barcode information obtainer and an image information obtainer is shown.

For example, as shown in FIG. 22, when an invoice number is input to an invoice number search window 710, image information about an article corresponding to the invoice number may be searched in operation 730 and displayed together on the screen. For example, one image information obtainer may be selected from among a plurality of image information obtainers in the invoice number search window 710. In this case, one piece of image information obtained from the selected one image information obtainer may be searched.

For example, as shown in FIGS. 22 and 23, a plurality of image information obtainers may be selected in the invoice number search window 710. In this case, a plurality of pieces of image information 810 and 830 obtained by the plurality of image information obtainers may be searched.

The devices and/or systems described above may be implemented as hardware components, software components, and/or a combination of hardware components and software components. The devices and components described in the disclosure may be, for example, implemented by using one or more implemented using one or more general-purpose computers or special-purpose computers, such as an arithmetic logic unit (ALU), a digital signal processor, a field programmable gate array (FPGA), a programmable logic unit (PLU), a microprocessor, or any other device that may execute and respond to instructions. A processing device may run an operating system (OS) and one or more software applications running on the operating system. Also, the processing device may also access, store, manipulate, process, and generate data in response to execution of software. For convenience of understanding, a case where one processing unit is used is described, but those skilled in the art will appreciate that a processing device may include multiple processing elements and/or a plurality of types of processing elements. For example, the processing device may include a plurality of processors or a processor and a controller. Also, other processing configurations are also possible, such as parallel processors.

Software may include a computer program, code, instructions, or a combination of one or more thereof, which may configure a processing device to operate as desired or may command the processing devices independently or collectively. Software and/or data may be permanently or temporarily embodied in any tangible machine, component, physical device, virtual equipment, computer storage medium or device, or transmitted signal wave to be interpreted by a processing device or to provide instructions or data to the processing device. Software may be distributed on networked computer systems and stored or executed in a distributed manner. Software and data may be stored on one or more computer-readable recording media.

The method may be implemented in the form of program instructions that can be executed through various computer units and recorded on a computer readable recording medium. A computer-readable recording medium may include program instructions, data files, data structures, etc. alone or in combination. Program instructions recorded on the medium may be specifically designed and configured for the examples or may be known and usable to those skilled in computer software. Examples of computer-readable recording media include hardware devices specifically configured to store and execute program instructions, such as magnetic media such as hard disks, floppy disks, and magnetic tapes, optical media such as CD-ROMs and DVDs, magneto-optical media such as floptical disks, and ROM, RAM, and flash memory. Examples of program instructions include high-level language codes that can be executed by a computer using an interpreter or the like, as well as machine language codes such as those produced by a compiler. The hardware devices described above may be configured to operate as one or more software modules to perform the operations of the examples, and vice versa.

As described above, a logistics control system and method capable of effectively tracking the moving states of articles by using a camera may be implemented.

In addition, the status of an article, that is, damage or theft of the article, and the position of the article may be checked by obtaining barcode information of the article and the color information of the article by respectively using two image sensors, which are synchronized.

In addition, the size, volume, or the like of the article may be calculated through the barcode information of the article, the color information of the article, a stereo function, or the like to be effectively used for logistics delivery. The scope of the disclosure is not limited by these effects.

It should be understood that disclosure described herein should be considered in a descriptive sense only and not for purposes of limitation. Descriptions of features or aspects within each example should typically be considered as available for other similar features or aspects in other examples. While one or more examples have been described with reference to the figures, it will be understood by those of ordinary skill in the art that various changes in form and details may be made therein without departing from the spirit and scope of the disclosure as defined by the following claims.

What is claimed is:

1. A camera comprised in a logistics control system, the camera comprising:
a barcode information obtainer configured to capture an image of a barcode of an article, which is attached to the article, and obtain barcode information of the barcode;
an image information obtainer configured in one housing with the barcode information obtainer and configured to obtain image information of the article by capturing an image of the article and be simultaneously triggered by one signal to have a synchronized photographing time point with the barcode information obtainer;
each of the barcode information obtainer respectively corresponding to each of the image information obtainer in the one housing;
the barcode information obtainer having better capability to recognize barcode information of the barcode in comparison to the barcode information obtainer's corresponding image information obtainer; and
a processor configured to monitor the article based on the barcode information and the image information.

2. The camera of claim 1, wherein the barcode information obtainer and the image information obtainer capture the article in a common field of view (FOV) area, and
the common FOV area is formed as a common area of a first capturing area captured by the barcode information obtainer and a second capturing area captured by the image information obtainer.

3. The camera of claim 2, wherein the barcode information obtainer and the image information obtainer are included in one system-on-chip (SoC) to be simultaneously triggered by one signal to have synchronized photographing time points.

4. The camera of claim 2, wherein the barcode information obtainer comprises a liquid lens.

5. The camera of claim 2, wherein a horizontal or vertical width of the common FOV area is equal to or greater than a width of a conveyor belt.

6. The camera of claim 2, wherein the barcode information obtainer comprises a mono sensor, the image information obtainer comprises a color sensor, and the image information obtainer obtains color information of the article.

7. The camera of claim 6, wherein the processor is further configured to generate article status information by inserting the barcode information of the article into a metadata area related to the color information of the article and map the barcode information of the article with the color information of the article based on the article status information.

8. The camera of claim 7, wherein the processor is further configured to check a status of the article or a position of the article based on the barcode information of the article and the color information of the article.

9. The camera of claim 1, further comprising a light-emitting diode (LED) arranged on one side of the housing.

10. A method of controlling a camera comprised in a logistics control system, the method comprising:
obtaining barcode information of an article by using a barcode information obtainer that captures an image of a barcode of the article, which is attached to the article, and obtaining image information about the object by using an image information obtainer that is configured as one housing with the barcode information obtainer and simultaneously triggered by on signal to have a synchronized photographing time point with the barcode information obtainer;
wherein each of the barcode information obtainer respectively corresponds to each of the image information obtainer in the one housing;
wherein the barcode information obtainer has better capability to recognize barcode information of the barcode in comparison to the barcode information obtainer's corresponding image information obtainer; and
monitoring the article based on the barcode information and the image information.
